(19) United States
(12) Patent Application Publication
(10) Pub. No.: US 2026/0019789 A1
(43) Pub. Date: Jan. 15, 2026

(54) LOCATION TRACKING AND PREDICTION DURING EMERGENCY SITUATIONS

(71) Applicant: RapidDeploy, Inc., Austin, TX (US)

(72) Inventors: Brett Meyerowitz, Cape Town (ZA); Steven Raucher, Austin, TX (US)

(21) Appl. No.: 18/767,190

(22) Filed: Jul. 9, 2024

(51) Int. Cl. H04W 4/90; G01C 21/34; H04W 76/50

(52) U.S. Cl. CPC H04W 4/90; G01C 21/3415; H04W 76/50

(57) ABSTRACT

An emergency response system handles emergency calls and may identify a location associated with the emergency for routing emergency responders to the emergency. Rather than routing responders to a single location, the emergency system monitors the location of a device associated with the emergency over time, receiving changed location information for the emergency as the situation changes. The updated location is used to modify the route provided to emergency responders by updating the route to change the destination of the mapped route to the changed location of the monitored device. As such, emergency responders may automatically account for dynamic emergency situations when device locations change over time.

### BACKGROUND

In emergency situations, the initial response time of first responders, such as police, fire, and/or emergency medical services (EMS) plays a vital role in ensuring that situations are managed as effectively and safely as possible. To direct first responders to emergency situations quickly, Public Safety Answering Points (PSAPs) or other emergency systems receiving emergency signals often utilize software, such as computer-aided dispatch (CAD) services, to gather information about emergency signals and in-field first responders. For example, CAD services may gather location information associated with incoming emergency signals, which may be provided as routing information to appropriate first responders by dispatchers.

However, locations of emergency situations may change over time. For example, during hostage or domestic violence situations, victims may be moved from one location to another in the time that it takes first responders to arrive. In another example, during natural disasters, search-and-rescue missions, or medical emergencies, survivors may move away from dangerous areas or to seek safety or rescue. In these and other emergency situations, location information may not be accurate by the time first responders arrive at known locations, potentially hindering efforts of the first responders to quickly and effectively manage emergency situations.

### SUMMARY

When an emergency signal is received, e.g., by a 911 call to a Public Safety Answering Point (PSAP), an emergency system receives location information for the emergency signal over time, ensuring that the location information used by in-field first responders assigned to the emergency situation remains up to date. While conventional applications receive only initial location information of emergency signals, the emergency system initiates ongoing location tracking for received emergency signals. Location tracking ensures that if a device associated with an emergency signal, such a mobile phone or vehicle, moves away from the initial location, the emergency system receives up-to-date current location information.

The emergency system may use the location tracking to send first responders directly to current locations of emergency situations, rather than to first-reported locations of emergency situations that may have since moved. In some embodiments, the emergency system transmits location information to in-field first responders as routing information. The routing information provides a route from a first responder's current location to the location of the emergency situation. The emergency system may transmit updates to the routing information as location tracking captures updated location information from emergency signals, thus automatically updating routing information for first responders approaching emergency situations.

Additionally, the emergency system may use the location tracking to predict future locations for emergency signals in motion. Based on a set of previous locations for an emergency signal, the emergency system determines a trajectory for the emergency signal (e.g., a bearing and/or route), and predicts a most-likely future location. Predicted future locations may be transmitted to first responders to enable them to intercept moving targets, such as stolen vehicles, hostage situations, or the like. These approaches reduce the overall response time for first responders arriving at emergency situations, many of which may be time-sensitive, as well as better ensuring safety of first responders by providing them with more accurate information about emergency situations and potentially circumventing the need for dangerous chases or tracking of targets.

### BRIEF DESCRIPTION OF THE DRAWINGS

FIG. 1 is an environment of a system for handling and displaying data associated with incidents, in accordance with one or more embodiments.

FIG. 2 is a block diagram of the emergency system, in accordance with one or more embodiments.

FIGS. 3A-D are example map interfaces for updating location information for an emergency situation, in accordance with one or more embodiments.

FIGS. 4A-B are example map interfaces for predicting future locations of emergency situations, in accordance with one or more embodiments.

FIG. 5 is an example flowchart for location tracking of signals for emergency situations, according to one embodiment.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Emergency Call Data Environment

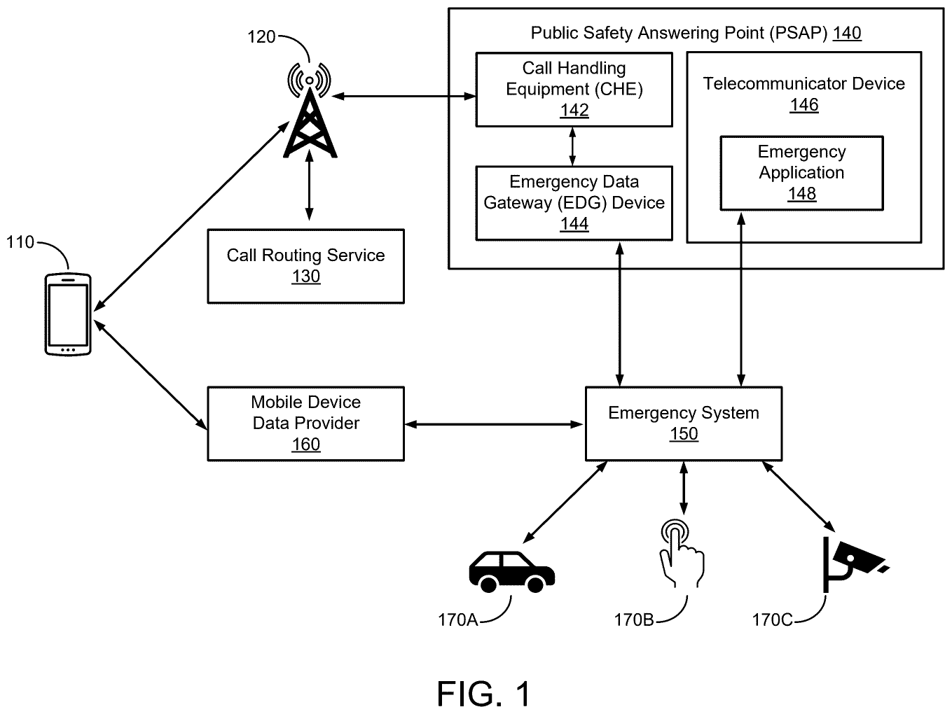

FIG. 1 is an environment of a system for handling and displaying data associated with incidents, in accordance with one or more embodiments. These incidents may generally represent time-sensitive, urgent, or emergency situations calling for coordinated response by a public safety authority. Such incidents may generally be represented by a call to a public safety number, although incidents may be identified by various means in different embodiments. Incidents, which may also be referred to herein as emergencies or emergency situations, may represent various types of events, such as reports of criminal activity, fires, disasters, dangerous animals or wildlife, and other types of time-sensitive events for which information and a coordinated response may be provided. When an incident is identified, it is typically associated with a physical location (which may be defined in any suitable way, such as a specific point location or as one or more geographic regions, e.g., as in a forest fire).

A public safety answering point (PSAP) 140, in conjunction with an emergency system 150, may coordinate a response to the incident, which may include dispatching responders to the location of the incident and providing additional support to the responders. Those who may respond to an emergency, such as police officers, firefighters, animal control, etc., may be referred to herein as responders, first responders, emergency response units, or individually as “units.” As such, a “unit” dispatched to an incident may represent a police vehicle with one or more police officers responding to the incident. To improve response times to incidents, the emergency system 150 provides a map-based interface for response coordinators (e.g., a telecommunicator operating a telecommunicator device 146) to view information about an incident, supplemental data that may be relevant to the incident, and coordinate a response to the incident directly from the map-based interface.

The environment includes a mobile device 110, a cell tower 120, a call routing service 130, a public safety answering point (PSAP) 140, an emergency system 150, a mobile device data provider 160, and secondary data sources 170A-170C. Only one of the mobile device 110, cell tower 120, call routing service 130, PSAP 140, and mobile device data provider 160 are shown for simplicity. In a working system environment, there may be more of each of these elements.

The mobile device 110 may be a cell phone, a smart phone, a tablet, or another device capable of initiating emergency reporting. The mobile device 110 is a device having a user interface (e.g., a touchscreen, buttons, microphone, speaker, camera, etc.) for interacting with a user and communications circuitry that connects the mobile device 110 to a communications network to initiate an emergency communication, e.g., to place an emergency call or send a text message. In this example, the mobile device 110 connects to a cellular network via the cell tower 120. In other examples, the mobile device 110 may additionally or alternatively connect to an Internet-based network via a wired or wireless connection (e.g., Wi-Fi), or to one or more other types of networks. While a mobile device 110 is shown in FIG. 1, other means of reporting an incident may also be used, such as a traditional wired telephone connection (e.g., a Plain Old Telephone Service (“POTS”)) or via a Voice-over-Internet-Protocol (VOIP) call from a fixed location.

The cell tower 120 is one component of a cellular network that enables wireless communication between mobile devices, and enables communication between wireless devices (e.g., the mobile device 110) and other networked communications devices or systems (e.g., the PSAP 140). Additional cell towers and other networking equipment are directly or indirectly coupled to the cell tower 120 for routing calls placed by mobile devices 110. When a user of the mobile device 110 makes an emergency call, such as a 911 call, the cell tower 120, or a network element coupled to the cell tower 120, interacts with a call routing service 130. The call routing service 130 determines an initial location estimate of the mobile device 110 based on the location of the cell tower 120. In some examples, the call routing service 130 may determine the location of the mobile device 110 based on alternative or additional information, such as the location of one or more additional cell towers in range of the mobile device 110, or a location provided by the mobile device 110.

The call routing service 130 routes the emergency call from the mobile device 110 to a particular PSAP 140 based on the initial location estimate. The PSAP 140 may cover a particular geographic region, such as a city, a county, a group of counties, a highway system, a park system, and so forth. The call routing service 130 identifies a PSAP (e.g., PSAP 140) that covers the location estimate of the mobile device 110 by comparing the location estimate of the mobile device 110 to the geographic boundaries associated with a set of PSAPs. The mobile device 110 communicates with telephony equipment in the selected PSAP 140 via the cell tower 120 and additional networking equipment not shown in FIG. 1.

The PSAP 140 is an emergency call handling system. The PSAP 140 includes call handling equipment (CHE) 142, an emergency data gateway (EDG) device 144, and a telecommunicator device 146 executing an emergency application 148. The CHE 142 receives and handles calls from the telephony network, which includes the cell tower 120. The CHE 142 creates a call event for each received call, such as an emergency call from mobile device 110. The CHE 142 associates call data, such as caller location information, call routing actions, Automatic Call Distribution (ACD) events, and other telemetry data, with the call event. Call data may also include the phone number and contact name of the user of the mobile device 110, class of service, service provider, a time stamp, and other information describing the user, mobile device 110, network, etc. The CHE 142 may output call data in one of a variety of data output formats, such as Automatic Location Information (ALI), Call Detail Record (CDR), or National Emergency Number Association (NENA) i3 Logging.

In the example shown in FIG. 1, an EDG device 144 installed at the PSAP 140 connects to the CHE 142. The EDG device 144 receives the call data from the CHE 142 and parses and formats the call data into a consistent data format. The EDG device 144 connects to an emergency system 150 via a network, such as the Internet, and the EDG device 144 transmits the formatted call data to the emergency system 150 via the network. The use of an EDG device 144 to transfer data from a CHE 142 to a cloud-based emergency system 150 is described in U.S. Pat. No. 10,264,122, incorporated by reference in its entirety. In another example, a central CHE host located outside the PSAP 140 receives call information for a group of PSAPs and distributes the call information to a selected PSAP, e.g., PSAP 140. In this example, a multi-tenant emergency call data relay may capture call data from the central CHE host and transmit the captured call data to the emergency system 150. The use of the data relay, and the data relay in combination with one or more EDG devices, is described in U.S. patent application Ser. No. 17/070,400, incorporated by reference in its entirety.

The PSAP 140 further includes a telecommunicator device 146. In this example, the telecommunicator device 146 is a computer system operated by a telecommunicator on-site at the PSAP 140. In other embodiments, the telecommunicator device 146 is at a different location from the PSAP 140, e.g., at a backup facility, mobile command center, remote worksite, etc. The telecommunicator device 146 includes the hardware and software to display user interfaces, connect to an IP-based network, and detect user input. The telecommunicator device 146 includes an emergency application 148 that allows interaction with the emergency system 150. In one embodiment, the emergency application 148 is a browser that allows a telecommunicator to access a web-based CAD service provided by the emergency system 150. In another embodiment, the emergency application 148 is a dedicated application provided by the emergency system 150 to enable interactions with the emergency system 150. The PSAP 140 may include multiple telecommunicator devices 146, each used by a different telecommunicator. Each telecommunicator device may have an associated position number.

The emergency system 150 assists telecommunicators in responding to emergency calls. The emergency system 150 may be a cloud-based processing system embodied on one or more computing systems that may be remote to the PSAP 140. While the emergency system 150 is shown as being outside the PSAP 140, in other embodiments, some or all of the functions performed by the emergency system 150 and described herein may alternatively be performed by on-site hardware located within a PSAP 140. Detailed functionality of the emergency system 150 is described below.

The emergency system 150 receives the formatted call data generated by the EDG device 144, processes the received formatted call data, and generates user interfaces for display by the emergency application 148. While one PSAP 140 is shown in FIG. 1, as noted above, the environment may include many similar PSAPs, and the emergency system 150 may receive call data from many PSAPs, e.g., from EDG devices 144 installed across many PSAPs. In addition, the emergency system 150 may receive call data from one or more multi-tenant emergency call data relays at one or more central emergency call handling hosts.

The emergency system 150 also receives supplemental data signals from one or more supplemental data sources. The supplemental data sources may be separate from the PSAP 140, and in particular, separate from the CHE 142 and EDG device 144, which provide the call data described above. The supplemental data signals provided by the supplemental data sources include data describing emergencies that reaches the emergency system 150 through one or more alternate pathways. Example supplemental data sources include the mobile device data provider 160 and the secondary data sources 170A-170C shown in FIG. 1. Supplemental data signals may include location information, contact information (such as a phone number, and/or alternative or additional data that can be used to correlate the supplemental data signal to an emergency call, such as a name, time stamp, location, etc. Additional and alternative supplemental data that may be included in a supplemental data signal are described below.

In addition to supplemental data signals that may indicate an incident (e.g., additional sources of information that may generate additional emergency incidents for which a response is coordinated), the emergency system 150 may also receive (or otherwise access) supplemental data that may be used or relevant to responding to incidents. Such supplemental data may include location information (e.g., of units that may respond to emergencies), mapping, routing, traffic, road hazards, weather, positional information for persons of interest (e.g., location information from a wearable monitor for persons on a suspended prison sentence or parole), additional emergency information from a governmental or other source (e.g., Integrated Public Alert and Warning System (“IPAWS” information)), real-time video or audio sources, and so forth. Supplemental data may also include data items related to characteristics, structures, objects, and so forth in the environment. Many types of supplemental data may also be associated with location/position information, such as information about the position of road hazards or a data item comprising the architectural schematic of a specific building. Such supplemental data may be filtered with respect to a particular incident and presented to a telecommunicator in a map-based interface to coordinate incident response as further discussed below.

The mobile device data provider 160 may also provide supplemental data signals related to the mobile device 110 making an emergency call. The supplemental data signals may include the location of the mobile device 110, frequent or saved locations of the mobile device 110, identifying information of the mobile device 110 (e.g., telephone number, contact name), a primary language of the caller and/or mobile device 110, medical history information, car crash detection data, a time stamp, and any other information that may be useful to the emergency system 150, a telecommunicator, and/or an emergency responder. In some embodiments, the mobile device data provider 160 automatically transmits the supplemental data signals to the emergency system 150 in response to an emergency call being placed by the mobile device 110. In some embodiments, the mobile device data provider 160 transmits the supplemental data signals in response to a query from the emergency system 150.

The mobile device data provider 160 may be a web server associated with a mobile device provider. For example, the mobile device data provider 160 is operated by a mobile phone company that programs the mobile device 110 to transmit its location to the mobile device data provider 160 when a user of the mobile device 110 initiates an emergency communication (e.g., when the user places an emergency call or sends an emergency text message). As another example, a mobile device data provider 160 is operated by a software provider whose software executes on the mobile device 110 and accesses the user device's location. In still another example, the mobile device data provider 160 is implemented by the mobile device 110, e.g., as a software module of the mobile device 110. In this example, the mobile device 110 is programmed (e.g., by a mobile device provider or software provider) to transmits its location and/or other supplemental data directly to the emergency system 150 in response to the user initiating an emergency communication. The system environment may include multiple mobile device data providers 160 associated with different mobile device providers and/or different software providers.

During an emergency call, the mobile device data provider 160 retrieves real-time location information from the mobile device 110 and transmits the location of the mobile device 110 to the emergency system 150 in a supplemental data signal. The mobile device 110 may determine its location based on, for example, satellite (e.g., GPS) signals, Wi-Fi signals, Bluetooth signals, cell towers, or other signals, or a combination of signals. The device-derived locations included in the supplemental data signals are typically more accurate and precise than the location provided in the call data, e.g., the locations based on cell phone towers used for routing calls. In addition, due to lags in existing call handling infrastructure, the device-derived locations are also typically available to the emergency system 150 faster than the call data, and faster than the device-derived locations are currently provided to on-site CAD system. Furthermore, the mobile device data provider 160 can continue to provide updated locations throughout an emergency call as the mobile device 110 moves location.

In addition to mobile devices, other secondary data sources 170 provide location data and/or other data about emergencies to the emergency system 150. While the secondary data sources 170 are illustrated as being in communication with the emergency system 150, data from the secondary data sources 170 may be transmitted from the secondary data sources 170 to the emergency system 150 via additional servers or other communications networks and devices, similar to the mobile device locations being passed to the emergency system 150 by the mobile device data provider 160.

Three example types of secondary data sources are illustrated in FIG. 1. The first example secondary data source 170A represents a vehicle data source. For example, the secondary data source 170A includes a vehicle communication provider that provides the location of the vehicle and vehicle condition information (e.g., whether a crash was detected) to the emergency system 150. A vehicle connected to the vehicle communication provider may alert the vehicle communication provider to an emergency in response to a user action (e.g., a user pressing a button in the vehicle) or automatically (e.g., in response to an automatic crash detection). The second example secondary data source 170B represents a panic button data source that provides the location of a user who pressed a panic button to the emergency system 150. A panic button provider may provide additional information to the emergency system 150 describing the user (e.g., medical history information) and, if available, the type of emergency (e.g., that the user reported a fall or a home invasion). The third example secondary data source 170C is a connected security system that may include one or more of a smart doorbell, a camera, a motion sensor, a fire detector, etc. In response to a user-initiated or automatically-detected emergency, a home security service that manages the connected security system may provide an address of the security system, any available real-time video, and other security data (e.g., lock tamper attempts, alarm triggers, etc.) to the emergency system 150. The emergency system 150 may receive additional or alternative secondary data signals from other types of secondary data sources besides those described herein.

The emergency system 150 may aggregate supplemental data signals received from the supplemental data sources 160 and 170 and call data received from PSAPs, such as the PSAP 140. For example, for a given call, the emergency system 150 receives call data from the EDG device 144, including the telephone number of the mobile device 110, and a supplemental data signal from the mobile device data provider 160 that includes a real-time location of the mobile device 110. By aggregating call data from the PSAPs and supplemental data signals, the emergency system 150 can provide a more complete picture of the emergencies within the jurisdiction of a given PSAP 140 than prior systems.

The emergency system 150 has access to additional data than a traditional on-premises CAD systems. First, the emergency system 150 may receive call data from multiple PSAPs. Call data from one PSAP may be relevant to a telecommunicator within a different PSAP, e.g., a neighboring PSAP or a PSAP with overlapping boundaries. For example, an emergency located within a first PSAP's jurisdiction may have been accidentally routed to a second neighboring PSAP, but it would be useful to a telecommunicator in the first PSAP to know about the emergency call.

In addition, the emergency system 150 receives information describing emergencies from one or more supplemental data providers. In some cases, a supplemental data signal regarding a given emergency call may arrive at the emergency system 150 sooner than the call data from a PSAP 140. For example, if a call is queued at the PSAP 140 and has not been assigned to a telecommunicator, the CHE 142 may not output any call data. In this case, the mobile device data provider 160 may provide caller information, including the location of the emergency and a phone number, to the emergency system 150 faster than the CHE 142 outputs the call data.

The emergency system 150 may also receive supplemental data signals describing emergencies for which the PSAP 140 does not receive an emergency call. For example, the mobile device data provider 160 provides locations and callback information for calls that do not get delivered to a PSAP 140 due to network outages or the call being dropped or hung up. As another example, a supplemental data provider provides data describing a mobile device 110 that attempted to text an emergency number such as “9-1-1” in a PSAP jurisdiction that does not support Text-to-9-1-1 and does not receive the text. As still another example, a supplemental data provider (e.g., a secondary data provider 170) provides information about car crashes or home burglaries for which an emergency call may not be placed. Based on information received from the supplemental data provider(s), a telecommunicator can begin routing resources to a location before answering the call. For example, a telecommunicator may begin routing resources in response to seeing a sudden spike in calls for a particular area.

### Example Emergency System

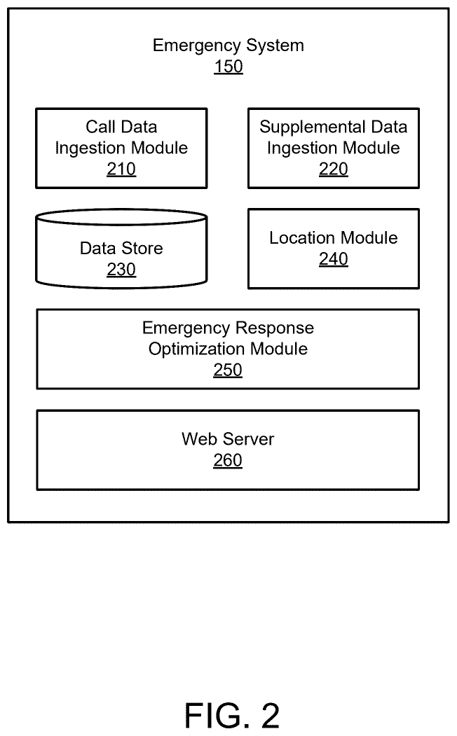

FIG. 2 is a block diagram of the emergency system 150, in accordance with one or more embodiments. The emergency system 150 includes a call data ingestion module 210, a supplemental data ingestion module 220, data store 230, a location module 240, an emergency response optimization module 250, and a web server 260. In alternative configurations, different and/or additional components may be included in the emergency system 150. Additionally, functionality described in conjunction with one or more of the components shown in FIG. 2 may be distributed among the components in a different manner than described in conjunction with FIG. 2 in some embodiments.

In one embodiment, the emergency system 150 is a cloud-based computer-aided dispatch (CAD) system that manages a CAD service that provides information about emergency calls and first responders to telecommunicators and enables telecommunicators to connect to first responders and dispatch first responders to the locations of emergencies. The cloud-based CAD system processes call data and supplemental data signals and provides information about an emergency caller to a telecommunicator via the emergency application 150. The cloud-based CAD system may also receive information from the emergency application 148 input by the telecommunicator, e.g., additional information about a caller, selections for responding to the call, information about first responders who were dispatched, etc. In another embodiment, the emergency system 150 is an emergency call mapping interface that provides data about emergencies in a region (e.g., the jurisdiction of a PSAP 140 or a region including the jurisdiction) on a real-time map. The emergency system 150 may provide a map-based interface in which the user (e.g., the telecommunicator) may view incidents, supplemental data that may be relevant to the incident, and coordinate a response to the incident. In still another embodiment, the emergency system 150 is a call analytics system that performs analysis on received emergency calls based on the call data and supplemental data signals.

The call data ingestion module 210 receives and processes call data related to emergency calls received at PSAPs, e.g., call data received by the EDG device 144 within the PSAP 140, and transmitted to the emergency system 150. The call data ingestion module 210 may receive and process call data from other sources, such as one or more multi-tenant emergency call data relays, which may be used in combination with one or more EDG devices. In some embodiments, the EDG devices are configured to transmit data to the emergency system 150 in a common format. In other embodiments, the call data ingestion module 210 is configured to parse and reformat data received from PSAPs into a common format used by the emergency system 150. The call data ingestion module 210 may determine whether each data message describes a new call or an existing call and associates call data related to the same call. The call data ingestion module 210 outputs call data to the data store 230. In some embodiments, the call data ingestion module 210 also outputs call data to one or more processing modules (e.g., one or more of the modules 240-260) for real-time processing.

The supplemental data ingestion module 220 receives and processes supplemental data signals provided by one or more supplemental data sources separate from the source of the call data, e.g., the supplemental data sources 160 and 170A-170C shown in FIG. 1. At least some of the supplemental data signals may include a location of an emergency. The supplemental data ingestion module 220 may parse applicable supplemental data signals and reformat the parsed supplemental data signal into a common format used by the emergency system 150. The supplemental data ingestion module 220 may determine whether each supplemental data signal is related to a prior supplemental data signal (e.g., an updated location, additional camera footage, etc.) or not, and may associate related supplemental data signals to streamline processing of follow-on data signals. The supplemental data ingestion module 220 thus outputs supplemental data signals and other received supplemental data to the data store 230. In some embodiments, the supplemental data ingestion module 220 also outputs supplemental data signals to one or more processing modules (e.g., one or more of the modules 240-260) for real-time processing. The supplemental data ingestion module 220 may have a respective data interface for each supplemental data source of type of supplemental data source, e.g., based on the data format or communication protocol used by the supplemental data source. In some embodiments, each supplemental data source has a respective corresponding data ingestion module, e.g., one data ingestion module for each mobile device data provider, and one data ingestion module for each secondary data source.

The data store 230 provides storage of the call data and supplemental data signals. The data store 230 may be encrypted. In some embodiments, the emergency system 150 includes a first data store for short-term storage (e.g., for ongoing emergency calls), and a second longer-term data store accessed to perform periodic analyses. In some embodiments, the emergency system 150 includes different data stores for call data and for supplemental data signals. The data store 230 may include one or more of a Binary Large OBject (BLOB) storage service, data warehouse, key-value database, document database, relational database, or any other type of data storage.

The location module 240 obtains location information corresponding to an emergency signal. The location information may be obtained in various ways in various embodiments, and generally permits the emergency system 150 to determine a location relevant to the emergency and determine changes to the location over time. In many instances, the location for the emergency may initially be obtained from data associated with the emergency call, for example, an emergency call initiated by a mobile device or by a vehicle's alert system. As the location of the emergency changes (e.g., the emergency device from which the call is initiated has a new location), the new location is determined by the location module 240.

In some instances, the location may be provided as supplemental data for the call and may be associated with the emergency call as provided by backbone call services. In some instances, when the location of the emergency device changes, the associated location of the call may also be updated with the call data, such that updated or supplemental call data is provided by the calling systems to indicate a change to the device location.

In further examples, the location module 240 may communicate with a device associated with the emergency to determine the location of the device. Such devices may determine their locations based on, for example, satellite data, latitude-longitude data, Wi-Fi data, local ambient signals, and so forth. In some circumstances the devices may provide a current location as determined by the device or may provide information from which the location of the device can be determined, such as a signature of the local environmental signals or other characteristics from which the location is determined.

As such, while the emergency system 150 may obtain location information from associated call data (i.e., supplemental data associated with an active emergency call), the emergency system 150 may also or alternatively obtain location information by communicating with a device associated with the emergency. For example, a mobile device may initiate the emergency call that is received by the emergency system 150 and may have associated location information with the emergency call. The emergency system 150 may message the mobile device separately from the call data (e.g., via separate messaging channels with a phone number, Internet Protocol (IP) address, or other address information associated with the call and/or mobile device) to communicate with the mobile device and obtain location information from the device. As such, the source of the location information may be from the emergency call or may be another channel from the emergency call, which may permit location monitoring and determination for a device associated with the emergency without relying on location messaging connected with the emergency call itself. As such, the emergency system 150 may communicate directly with a device associated with a location of the emergency separately from the call, further enabling location monitoring for the emergency even when the calling infrastructure for the call does not provide or permit updated location information for the call and when the emergency call ends. This may be particularly effective in circumstances where the traditional call infrastructure does not provide updates and the device (and emergency) are likely to move over time, such as emergencies on water.

In addition to monitoring the location of the device that placed the emergency call, in some embodiments, the location associated with the emergency may also be determined based on another device. For example, the device used to determine the relevant location of the emergency may initially be determined from the device placing the emergency call. In some circumstances, the device associated with the emergency may be changed to another device, such as another mobile device or another device for which location information is available. For example, the initial location of the emergency may be determined based on the location of the emergency call. The location module 240 may determine the location of devices near the reported location and determine another device that may be used to report a location of the emergency. For example, an emergency call may be placed by a user in a vehicle with a mobile device. The initial location may be based on the location information associated with the emergency call. Rather than monitor the location of the mobile device or the call, which may be subject to interruptions (such as a loss of the call or insufficient power on the mobile device), the relevant device for location monitoring may be changed to the vehicle (when the vehicle is capable of communication with the emergency system 150 and reporting a location). The other device may be automatically determined or may be designated by an operator of the emergency system 150. For example, the device used to monitor the emergency (which may differ from the device reporting the emergency) may be determined by identifying a set of devices having a location at or near the location of the initially-reported emergency location. The location module 240 may automatically select a closest eligible device to the reported emergency location to determine the device to monitor for the emergency. In further examples, the monitored device may be selected by an operator of the emergency system 150, such as an emergency responder handling the emergency call. For example, the emergency responder handling the call may view the eligible devices and confirm with the emergency caller which device may best represent the emergency for ongoing location monitoring.

When monitoring the location of a device associated with the location, the emergency system 150 may receive the updated location information from the device or may actively poll the device to report the location. In some embodiments, the location tracking may continue while the emergency is active, such that the location associated with the emergency may continue after the emergency call has ended. The location data may be provided by the device based on Wi-Fi, cellular network data, or other location systems and may be provided continuously or at a designated frequency (e.g., each thirty seconds, minute, five minutes, etc.).

The emergency response optimization module 250 receives location information from the location module 240 and may be used to update route information for emergency responders. The emergency response optimization module 250 may also obtain further information such as traffic conditions, road information, proximity information, and so forth, to determine routing information to a location associated with the emergency. The emergency response optimization module 250 then transmits the location of the emergency and/or the route to devices operated by one or more emergency responders. In various embodiments, the emergency responder devices may be configured to receive a destination or a route from the emergency response optimization module 250. That is, depending on the configuration of the device operated by an emergency responder, the device may be configured to receive a destination for the emergency response, in which case, the responder's device may operate a mapping/routing module/component to obtain routing to the specified destination. In other examples, the emergency responder's device may be configured to receive a route from the emergency system 150 and display the route on the device for the emergency responder to be routed to the location of the emergency.

As the location associated with the emergency (e.g., as determined from the relevant device from the location module 240) may change over time, the emergency response optimization module 250 may thus update the emergency responder devices with updated destinations and/or route information. When the emergency responder device is configured to generate routes based on a destination, the location of the emergency may be used as the destination for generating a route for the emergency responder's device. When the emergency location changes, an updated destination for the emergency responder device is sent by the emergency system 150 to the emergency responder device. When the emergency responder device receives the updated location, the updated destination is applied for the emergency responder device to modify the displayed route to the updated location. For example, the emergency system 150 may be in communication with an emergency application or other module of the device associated with emergency response and provide the updated location to the device. The responder device (i.e., the relevant application or mobile) may provide the location as a destination to a mapping/routing application of the device, thereby providing routing information to the emergency responder that automatically accounts for the changing location of the emergency by changing the destination for the route (whether generated by the responder device or the emergency system 150).

As such, the emergency response optimization module 250 coordinates updating the route displayed to one or more emergency responders on the respective emergency responder devices based on the received/updated location from the location module 240. In some embodiments, the route may be updated whenever an updated location is received by the location module 240. In further embodiments, the route may be conditionally updated based on whether the updated location is different (or substantially different) from a current location (i.e., routing destination) associated with the emergency. Thus, when the location remains the same, no change to the route may be made. When the emergency location is changed above a threshold amount, the route may then be re-determined to provide a route to the emergency responder to the updated location.

The emergency responder may thus receive updated routes automatically as the location of the emergency changes. When responders are assigned to a particular emergency, associated devices may receive a location/route to the emergency based on the current location associated with the emergency and may subsequently receive updated locations (as a revised destination for the route) when the emergency location changes. Assigned responders may thus have the routing information automatically populated with the updated locations for the emergency.

In embodiments in which the location information is updated separately from the emergency call, this may enable dynamic and changing emergency locations to be automatically updated for emergency responders without requiring data from the emergency call or intervention from a call handler; the updated location can automatically be updated for the route provided to the emergency responder, ensuring more efficient emergency response.

In further embodiments, in addition to providing updated location information, the changing location information may also be used to determine a trajectory and/or predicted location for the emergency. The predicted location may then be used as a destination for the route instead of or as a supplement to the current location of the emergency. In quickly-moving emergencies, the trajectory information may enable improved routing for emergency personnel to anticipate changes to the emergency location. The routing to the predicted location may then enable assigned emergency responders to intercept the emergency at the future location rather than “following” past locations of the emergency. The predicted location of the emergency may be determined based on historical movement of devices and locations associated with emergencies along with other factors, such as the available routes for vehicles or other systems associated with the emergency.

The web server 260 provides user interfaces to telecommunicators providing emergency response assistance. A user interface provided by the web server 260 to a telecommunicator in a given PSAP 140 includes a map that may include user interface elements relating to an incident and information to enable the telecommunicator to respond to the incident within the map-based interface. For example, the interface may include supplemental signal indicators corresponding to the supplemental data signals mapped to the PSAP 140. Each supplemental signal indicator is positioned on the map at the location indicated by the supplemental data signal. Each supplemental signal indicator may have a visual characteristic indicating the status of a call corresponding to the supplemental signal indicator. For example, the visual characteristic may indicate whether a corresponding call has been received at the telecommunicator's PSAP, whether a corresponding call has been answered by the telecommunicator, whether a corresponding call has been answered at a different PSAP, and whether a threshold amount of time has elapsed since the call supplemental signal indicator was received without a corresponding call being answered. The web server 260 may provide additional supplemental data via the user interfaces and provide for the selection of relevant supplemental data and coordination of a response via the interface. Example user interfaces provided by the web server 260 are shown in the user interface Figures discussed below. The various user interface functions described herein as being performed by the web server 260 or by the user interface may be performed by the web server 260 (e.g., in a thin client implementation) or at the emergency application 148 based on data and instructions provided to the telecommunicator device 146 by the web server 260 (e.g., in a fat client implementation).

The web server 260 maintains information identifying each telecommunicator accessing the emergency system 150, such as a PSAP identifier and the telecommunicator's position number within the PSAP. For a given telecommunicator, the web server 260 selects data from the data store 230 or one or more other components of the emergency system 150 for display to the telecommunicator. For example, the web server 260 selects call data for calls matching the telecommunicator's PSAP identifier and position number, supplemental data signals related to the selected calls, and supplemental data signals mapped to the PSAP. The user interface may be user-configurable, and the web server 260 may select data for display based on user selections. For example, a user may request to view call data and supplemental data related to all calls currently being handled by a given PSAP, all calls within a given region, a subset of calls handled by the PSAP, data matching a particular search term, etc.

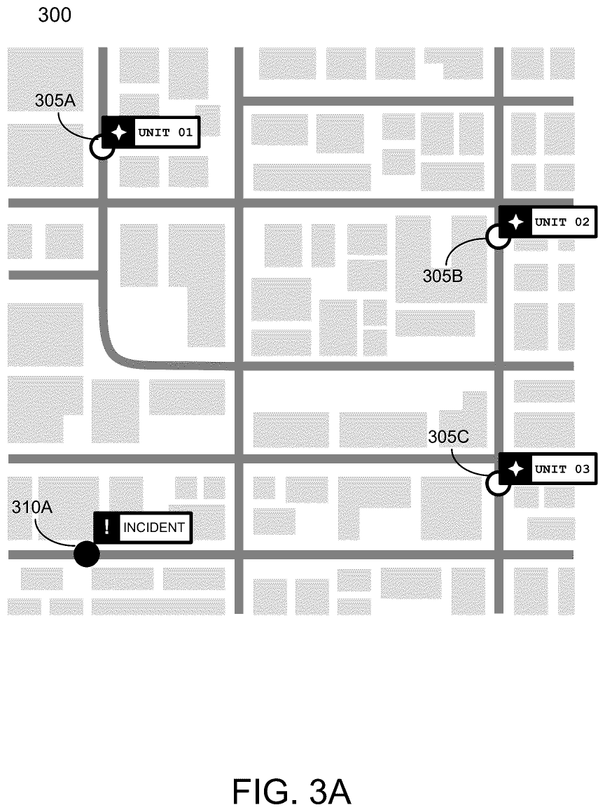

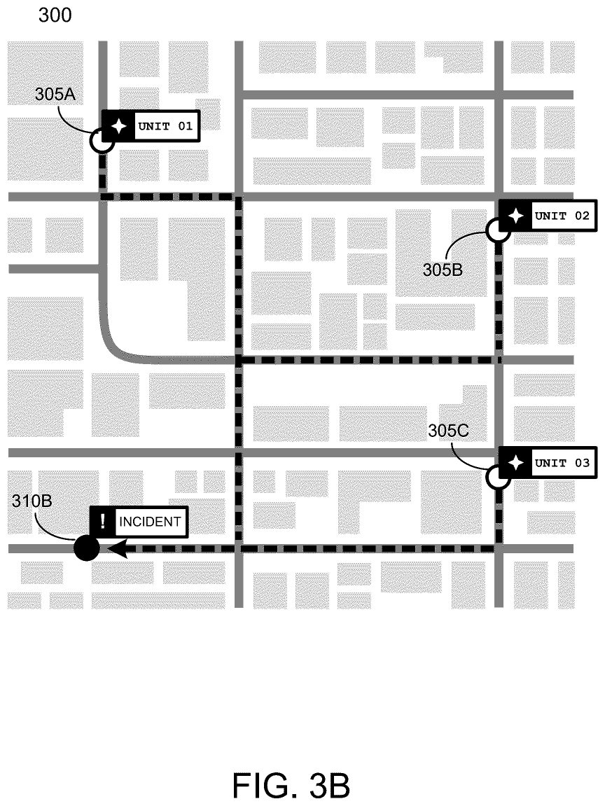

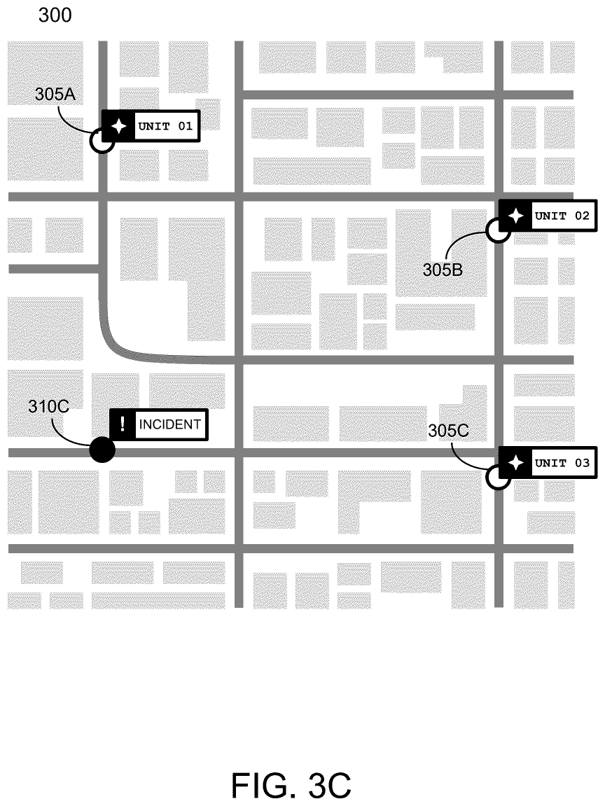

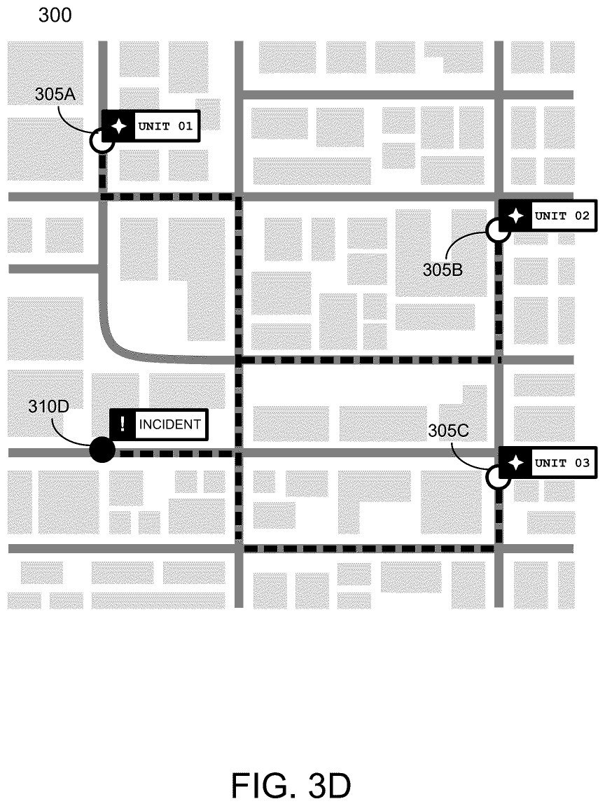

FIGS. 3A-3D are example map interfaces for updating location information for an emergency situation, in accordance with one or more embodiments. FIG. 3A shows a map interface 300 comprising an active emergency incident 310A and one or more emergency response units 305. In some embodiments, the map interface 300 of FIG. 3A may be an interface displayed to a user of the emergency system 150, such as a dispatcher, and may comprise additional or different information than shown here, such as identifiers for the emergency response units 305, additional devices or relevant responders, or the like. In this example, the emergency incident 310A and the emergency response units 305A-C have positions on the map interface 300 representative of their respective locations in an environment.

In some embodiments, the location of the emergency incident 310A is automatically placed on the map interface 300 responsive to the emergency system 150 receiving an emergency signal. The emergency signal may be, for example, a 911 call from a mobile device. Responsive to the emergency system 150 receiving the emergency signal, the emergency system captures location information associated with the emergency signal and populates the emergency incident on the map interface 300 with a signal indicator placed at the first location. In other embodiments, the location of the emergency incident 310A is manually placed on the map interface 300, e.g., responsive to a dispatcher or other user of the emergency system 150 determining that a received emergency signal represents an emergency situation.

When a user of the emergency system 150 assigns one or more emergency response units 305 to an emergency incident, the emergency system 150 determines and transmits routing information to each assigned emergency response unit, as in FIG. 3B. Routing information may be based on known road systems, as well as on one or more supplemental signals and information, such as current weather and traffic conditions associated with possible routes, the type of emergency incident, the type of one or more emergency response units, and so on. Routing information represents a most direct or quickest path for an emergency response unit 305 from a respective current location to the emergency incident 310B.

In the example of FIG. 3B, the emergency system 150 assigns the emergency incident 310B to emergency response units 305A, B, C and provides routing information to each emergency response unit. In other examples, emergency incident 310B may be assigned to additional or fewer emergency response units, e.g., the emergency incident may be assigned only to one emergency response unit.

While the routing information provided by the emergency system 150 identifies a most direct path for the emergency response units 305 to the emergency incident 310, in various cases, emergency situations may evolve over time, such that the location of the emergency moves from one location to another, such that routing information may no longer accurately direct emergency response units 305 to the correct location. In the example of FIG. 3C, the emergency system 150 receives a current location for emergency incident 310C as having moved to a new street prior to the emergency response units 305A-C arriving. Responsive to receiving the update to the current location, the emergency system 150 updates the map interface 300 to place the signal indicator of the emergency signal on the second location.

Changes in locations of emergency incidents may occur for many reasons. For example, during hostage, abduction, or domestic violence situations, victims may be transported from one place to another. Similarly, during emergencies in rural or maritime environments wherein response times may be higher, individuals may move in search of safety or to avoid danger. During maritime emergencies in particular, location changing may be inevitable due currents or winds, such that a static location almost always provides difficulties for rescue attempts.

Responsive to the emergency incident 310C having moved, the emergency system 150 determines updated routing information for each assigned emergency response unit. Alternatively, the updated emergency location is provided to the emergency responder devices for updating the destination and resulting routing information by a mapping or routing application on the device. FIG. 3D illustrates updated routing information for each of the assigned emergency response units 305A-C to the current location of the emergency incident 310D.

As discussed above, the updated routing and location updates may be provided to the emergency responders to improve displayed routes for responders to the incident. As one example, when an emergency call is received by a dispatcher, an initial location for the emergency may be identified based on supplemental data associated with the call. The device associated with the call may be identified (e.g., as accessible by a telephone number or IP address) and the emergency system may communicate with the device to determine the updated location of the device over time. The updated location of the device associated with the emergency may then be sent to update routing of the emergency responders. As the location for the emergency can be updated during and after the emergency call completes, the updated routing may account for many types of emergency situations as the relevant location for the emergency changes.

In some embodiments, the emergency system 150 may continue to receive location information describing the emergency incident 310, such that further changes in location to the emergency incident may be detected. The emergency system 150 may continually update the current location of the emergency incident 310, and may continually update the routing information for each of the assigned emergency response units 305, such that the routing information provided to the assigned emergency response units is up to date. In some embodiments, the emergency system 150 may update the location of the emergency incident 310 and/or the routing information periodically, e.g., at a set frequency, so as to avoid confusion by the emergency response units 305 following the routing information and/or to avoid overloading systems for determining routing information.

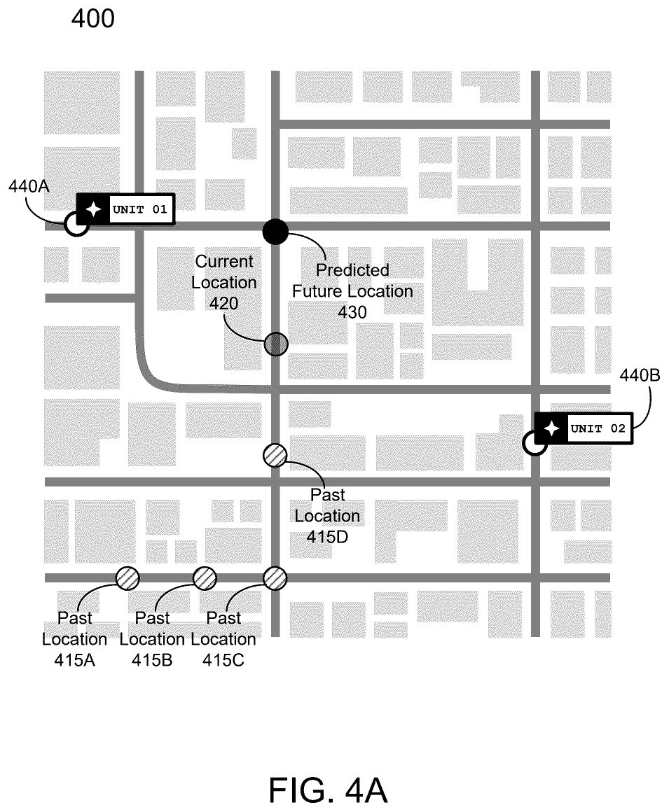

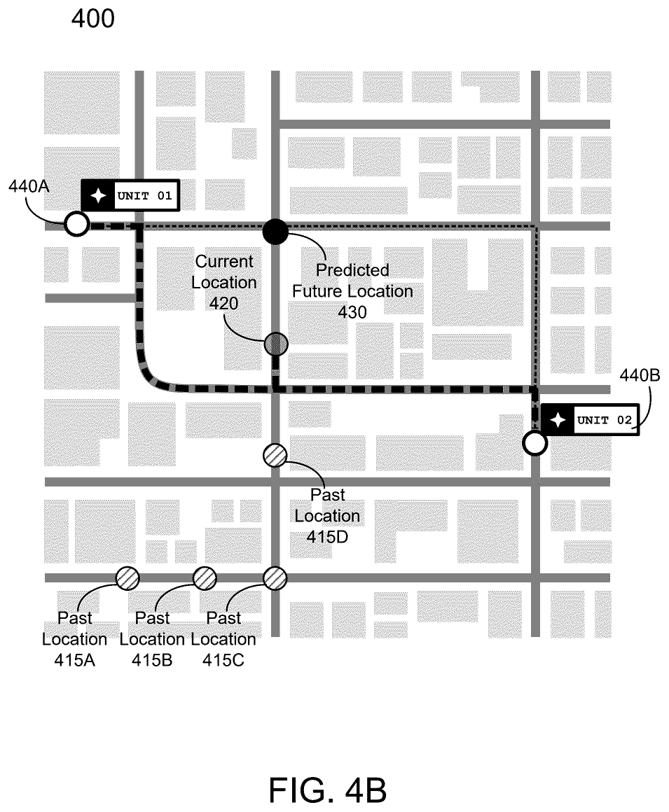

FIGS. 4A-B are example map interfaces for predicting future locations of emergency situations, in accordance with one or more embodiments. FIG. 4A shows a map interface 400 comprising an active emergency incident having a current location 420 and one or more emergency response units 440. In some embodiments, the map interface 400 of FIG. 4A may be an interface displayed to a user of the emergency system 150, such as a dispatcher, and may comprise additional or different information than shown here, such as identifiers for the emergency response units 440A-B, additional devices or relevant responders, or the like.

During location tracking of an emergency signal, the emergency system 150 may store one or more past locations 415 associated with the emergency situation. In some embodiments, the emergency system 150 may store a most recent set of past locations 415, e.g., a most recent 5 or 10 locations, or may store all known past locations received by the emergency system. Past location information 415 may be determined from a time at which the emergency signal is first received, e.g., such that a first past location 415A is a first, current location received by the emergency system 150 when an emergency signal is received, or may be determined retroactively, e.g., by receiving historic location data from a device associated with the emergency signal.

Based on past locations 415 and current location 420 of the emergency signal, the emergency system 150 determines a trajectory of the emergency signal. The trajectory of the emergency signal may comprise a bearing and an average movement speed. In some embodiments, the trajectory of the emergency signal may be based at least in part on a mode of transportation associated with the emergency signal. For example, the emergency system 150 may determine that an emergency signal having past locations 415 on paved roads and having average speeds of over 35 mph as most likely corresponding to a motor vehicle, while an emergency signal having past locations in a body of water most likely corresponds to a boat or other water vehicle and an emergency signal crossing pedestrian-only areas and being less than a threshold speed most likely corresponds to a target on foot. In various other examples, the emergency system 150 may determine that an emergency signal corresponds to drones, planes or other aerial vehicles, bicycles, trains, buses or other public transport, or the like.

The emergency system 150 predicts a future location 430 of the emergency signal based at least in part on the trajectory of the emergency signal. The predicted future location 430 may also depend at least in part on one or more supplemental signals, such as traffic and/or road conditions or closures in the area, weather conditions in the area, and the like.

When emergency response units 440 are assigned to the incident, the emergency system 150 may generate and transmit routing information to the predicted future location 430 of the emergency signal rather than to the current location 420. As shown in FIG. 4B, routing units 440 to the predicted future location 430 may enable emergency response units 440A-B to intercept an emergency situation rather than pursuing or chasing a potentially dangerous target. In some embodiments, the emergency system 150 may provide different sets of routing information to different emergency response units 440, e.g., such that a first emergency response unit 440A is routed to the predicted future location 430 while a second emergency response unit 440B is routed to the current location 420, so as to minimize risk of the predicted future location being incorrect. In other embodiments, the emergency system 150 may provide multiple sets of routing information to an emergency response unit 440, such that first responders may identify both a current location 420 of an emergency signal and a predicted future location 430 of the emergency signal.

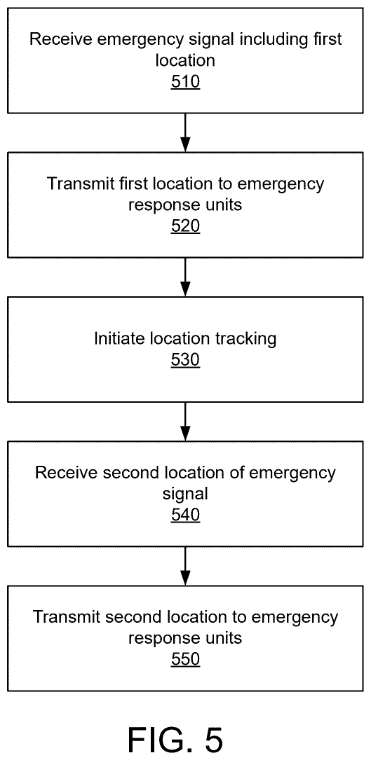

FIG. 5 is an example flowchart for location tracking of signals for emergency situations, according to one embodiment. Alternative embodiments may include more, fewer, or different steps from those illustrated in FIG. 5, and the steps may be performed in a different order from that illustrated in FIG. 5. These steps may be performed by an emergency system, e.g., emergency system 150, or may be performed in part or in whole by one or more other systems. Additionally, each of these steps may be performed automatically by the emergency system without human intervention.

As also discussed above, the method initially may begin when an emergency signal is received 510 indicating the presence of an emergency at a location. An initial location of the emergency may represent a first location for directing emergency responders to the emergency and may be a location associated with an incoming emergency call. The location may be determined based on supplemental information associated with the emergency call. When the emergency signal is received, the first location is transmitted 520 to emergency response units (i.e., to devices operated by emergency responders) for display of a route to the first location.

The emergency response system may then initiate 530 location tracking for a device associated with the emergency. As discussed above, the device may be the device that made the emergency call, or may be a different device associated with the emergency and may represent an appropriate destination for the emergency. As additional location information is received 540 for the monitored device, the location is used as an updated location for routes of emergency responders by transmitting 550 the second location to the emergency responders. The second location may be sent as part of a route to the second location or may be sent such that the responder's device determines a route to the location. As discussed above, the monitored location may be updated at various frequencies and the second location may be sent conditional on the location being sufficiently different from the first location. In addition, the second location used to update the route may be a predicted location that describes expected movement of the monitored device, enabling the displayed route to more effectively route emergency devices to the location of the emergency. Together, these systems enable coordination between emergency calls, location monitoring for appropriate devices, and coordination of emergency responders that allow route adjustment for dynamically changing emergencies. This permits the emergency system 150 to handle locations as may be provided by an emergency call and as may be obtained by a relevant device after the emergency is identified, such that the relevant device for monitoring the changing emergency location can differ from the device that placed the emergency call when appropriate.

### Additional Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a desktop agent. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

What is claimed is:

1. A method comprising:
receiving an emergency signal comprising a first location;
transmitting the first location of the emergency signal to one or more emergency response units, wherein transmitting the first location automatically generates routing information for each emergency response unit to a destination of the first location;
initiating location tracking of the emergency signal, the location tracking determining current location of the emergency signal;
receiving a second location of the emergency signal different from the first location; and
transmitting the second location of the emergency signal to the one or more emergency response units, wherein transmitting the second location of the emergency signal updates the routing information for each emergency response unit to the second location as the destination.

2. The method of claim 1, wherein location tracking determines the current location of the emergency signal at a set frequency.

3. The method of claim 1, wherein the location tracking determines the current location of the emergency signal continuously.

4. The method of claim 1, further comprising:
determining a trajectory of the emergency signal based at least in part on the first location and the second location;
based on the trajectory, identifying a predicted future location of the emergency signal; and
transmitting the predicted future location of the emergency signal to the one or more emergency response units.

5. The method of claim 1, further comprising determining, based on the location tracking, that the emergency signal corresponds to one or more of: a pedestrian, a car or other motor vehicle, a bicycle, or a boat or other water transport.

6. The method of claim 1, further comprising transmitting one or more notifications describing the emergency signal to a subset of the one or more emergency response units, wherein the subset is determined based on proximity of the emergency response units to a current location of the emergency signal.

7. The method of claim 1, further comprising:
providing a map interface, the map interface comprising a signal indicator positioned on the map interface at the first location of the emergency signal; and
responsive to receiving the second location, updating the map interface, such that the signal indicator is positioned on the map interface at the second location of the emergency signal.

8. The method of claim 1, wherein the routing information is an optimized route based on current traffic locations and updated locations of the respective emergency response units.

9. The method of claim 1, wherein the emergency signal is an emergency call, and further comprising forwarding the emergency call to an emergency response unit of the one or more emergency response units.

10. The method of claim 1, wherein the emergency signal is an SOS or alert signal from a vehicle alarm system.

11. The method of claim 1, wherein one or more of the emergency response units comprises a drone, further comprising receiving additional location information of the emergency signal based on a location of the drone.

12. A system, comprising:
a processor; and
a non-transitory computer-readable storage medium comprising instructions that are executable by the processor for:
receiving an emergency signal comprising a first location;
transmitting the first location of the emergency signal to one or more emergency response units, wherein transmitting the first location automatically generates routing information for each emergency response unit to a destination of the first location;
initiating location tracking of the emergency signal, the location tracking determining current location of the emergency signal;
receiving a second location of the emergency signal different from the first location; and
transmitting the second location of the emergency signal to the one or more emergency response units, wherein transmitting the second location of the emergency signal updates the routing information for each emergency response unit to the second location as the destination.

13. The system of claim 12, wherein location tracking determines the current location of the emergency signal at a set frequency.

14. The system of claim 13, wherein the location tracking determines the current location of the emergency signal continuously.

15. The system of claim 13, where in the instructions are further executable for:
determining a trajectory of the emergency signal based at least in part on the first location and the second location;
based on the trajectory, identifying a predicted future location of the emergency signal; and
transmitting the predicted future location of the emergency signal to the one or more emergency response units.

16. The system of claim 12, wherein the instructions are further executable for determining, based on the location tracking, that the emergency signal corresponds to one or more of: a pedestrian, a car or other motor vehicle, a bicycle, or a boat or other water transport.

17. The system of claim 12, wherein the instructions are further executable for transmitting one or more notifications describing the emergency signal to a subset of the one or more emergency response units, wherein the subset is determined based on proximity of the emergency response units to a current location of the emergency signal.

18. The system of claim 12, wherein the instructions are further executable for:
providing a map interface, the map interface comprising a signal indicator positioned on the map interface at the first location of the emergency signal; and
responsive to receiving the second location, updating the map interface, such that the signal indicator is positioned on the map interface at the second location of the emergency signal.

19. The system of claim 12, wherein the routing information is an optimized route based on current traffic locations and updated locations of the respective emergency response units.

20. The system of claim 12, wherein the emergency signal is an emergency call, and wherein the instructions are further executable for forwarding the emergency call to an emergency response unit of the one or more emergency response units.
